(19) United States
(12) Patent Application Publication
(10) Pub. No.: US 2012/0228235 A1
(43) Pub. Date: Sep. 13, 2012

(54) Method and System for Purifying Water

(76) Inventor: Virendra J. Mehta, Panjim (IN)

(21) Appl. No.: 13/509,609

(22) PCT Filed: Jun. 16, 2010
(86) PCT No.: PCT/IN2010/000408

§ 371 Date: May 13, 2012

(30) Foreign Application Priority Data
Nov. 13, 2009 (IN) 2624/MUM/2009

(51) Int. Cl. C02F 1/00; B01D 33/48; C02F 1/32

(52) U.S. Cl. 210/748.11; 210/806; 210/252; 210/251; 210/791

(57) ABSTRACT

The present invention describes a method and system for purifying water. The method includes filtering water in one or more filtering units. A filtering unit is configured within a tank of one or more tanks that collects the filtered water. The filtered water is then re-filtered by one or more filter turbines to obtain re-filtered water. The re-filtered water is then purified by one or more treatment units. A treatment unit is connected to a filter turbine. In an embodiment of the invention, the water purified may be a ballast water present in a water vessel.

### FIELD OF THE INVENTION

The invention generally relates to purification of water. More specifically, the invention relates to filtration and purification of water from different sources such as, sea, river, ground water, sewage water.

### BACKGROUND OF THE INVENTION

Urbanization and rising population has lead to increased demand for well treated water for consumption. Continuous efforts have been made to treat industrial waste water, municipal water, sewage water, etc. before they are directed to the streams, sea and rivers. Even though such efforts have been made degradation of existing supply of fresh water continues due to contamination of water sources. Water from various sources such as ground water, river etc., needs to be well treated so that purity of water is at an acceptable level for consumption by people, industries and other purposes.

Treatment of water present in a water vessel is equally important to maintain ecological balance in a water body. For example, a water vessel such as, sea vessel is used to carry cargo from one port to another. During transportation of cargo between ports, it may happen that the water vessel returns empty after unloading its cargo at a first port. This may lead to instability of the water vessel due to change in overall weight of the water vessel. To maintain stability after unloading cargo, water such as, sea water is filled into one or more ballast tanks of the water vessel. Water filled in the one or more ballast tanks of the water vessel is known as ballast water. Ballast water provides the water vessel with stability and structural integrity. Also, ballast water helps in submergence of propeller and rudder of the water vessel. Ballast water thereby increases maneuverability of the water vessel and reduces amount of exposed surface of a hull of the water vessel. The water vessel discharges ballast water when cargo is loaded at a second port.

During filling of ballast water, species of bacteria, plants and animals may be picked up in ballast water and these may sustain in one or more ballast tanks of the water vessel for a long duration. Therefore, these may get released to the second port while discharging of ballast water into a water source of the second port. The water source may be sea, a river, a lake, etc. This may result in upsetting ecological balance of the water source such as, sea. It is therefore important to ensure that minimum living organisms are transported along with ballast water to another port.

Research has shown that living organisms present in shallow water of a port cannot survive in deep water because of different environmental conditions and vice-a-versa. Considering the above, International Maritime Organization (IMO) has recommended for exchanging ballast water of sea vessels in deep sea.

One of the prevailing methods used for ballast water exchange as recommended by the IMO is a sequential method. In the sequential method, one or more ballast tanks of the water vessel are emptied and then refilled. The sequential method removes large weights from the water vessel in the form of ballast water before replacing those weights by filling in new ballast water. This may lead to over and under pressurization of one or more ballast tanks The sequential method also generates free surface effect which may affect stability of the water vessel. Further, the sequential method may result in excessive shearing forces, torsional forces and bending moments being applied to the water vessel.

There is therefore a need for purification of water so that the water can be consumed. Further, there is a need for purification of ballast water in a water vessel in a way that maintains ecological balance of water source such as, sea water.

### SUMMARY OF THE INVENTION

An objective of the invention is to provide a method and system for removing impurities including, but not limited to, sand, sediments, other deposits, bacteria and pathogens from water.

Another objective of the invention is to provide a method and system for purifying the water for consumption.

Another objective of the invention is to provide a method and system for safely performing water exchange by a water vessel with water bodies without upsetting the ecological balance of the water bodies.

Another objective of the invention is to provide a method and system for safely performing ballast water exchange without upsetting the ecological balance of sea water.

The above listed and various other objectives are achieved by providing a method and system for purifying water. The method includes filtration of water by specially designed filter turbine by making use of water pressure head to enhance flow rate by gravity. The method further includes purifying water in a tank of one or more tanks before pumping ballast water to fill other tanks for subsequent distribution.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a purification system for purifying water in accordance with an embodiment of the invention.

FIG. 2 illustrates a section view of filter turbine in accordance with an embodiment of the invention.

FIG. 3 illustrates a longitudinal section view of a sea vessel.

FIG. 4 illustrates a transverse section view corresponding to axis A-A′ in FIG. 3.

FIG. 5 illustrates a transverse section view corresponding to axis B-B′ in FIG. 3.

FIG. 6 illustrates a cross-section view of a water vessel showing a purification system in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### Definitions

Ballast tank: It is a compartment within a water vessel that holds water.

Double Bottom Segregated Ballast tank: It is a compartment within a water vessel that is divided by the floors and keelsons between inner and outer bottom of the water vessel.

Side Segregated Ballast tank: These ballast tanks are located on either side of a water vessel providing protection to cargo tanks in case of collision.

After peak ballast tank: It is an enclosed space immediately forward of the sternpost and aft of the aftermost watertight bulkhead of a water vessel.

Fore peak ballast tank: It is an enclosed space immediately forward of the fore collision bulkhead of a water vessel.

Bow: It refers to the forward part of the hull of a water vessel, the point that is most forward when the water vessel is underway.

Stern: It is the rear or aft part of a water vessel, technically defined as the area built up over the sternpost, extending upwards from the counter to the taffrail. The stern lies opposite of the bow, the foremost part of the water vessel.

Keel: It is a large beam around which the hull of a water vessel is built. The keel runs in the middle of the water vessel, from the bow to the stern, and serves as the foundation or spine of the water vessel structure, providing major source of structural strength to the hull. It is the lowest part of the water vessel.

Draft: It is the vertical distance between the waterline and keel of a water vessel. Draft determines the minimum depth of water the water vessel can safely navigate.

Hull: It is the body of a water vessel. It is a central concept in water vessels as it provides the buoyancy that keeps the water vessel from sinking

Starboard side: It refers to the right side of a water vessel as perceived by a person on board the water vessel and facing the bow.

Port Side: It refers to the left side of a water vessel as perceived by a person on board the water vessel and facing the bow.

Sea chest: It is an opening in the hull of a water vessel on either sides for the purpose of ballasting and deballasting the ballast tanks of the water vessel.

Bulkhead: It is a division or partition that divides a water vessel into compartments, increases structural rigidity and prevents spreading of leakage or fire.

Bell mouth: It is a bell shaped opening in a pipeline located inside a ballast tank of a water vessel and fitted with valve. It is used either as a suction inlet or discharge outlet for ballasting or deballasting the ballast tanks of the water vessel.

### DETAILED DESCRIPTION OF THE INVENTION

Before describing in detail embodiments that are in accordance with the invention, it should be observed that the embodiments reside primarily in combinations of method steps and system components related to method and system for purifying water. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally speaking, pursuant to various embodiments, the invention provides a method and system for purifying water.

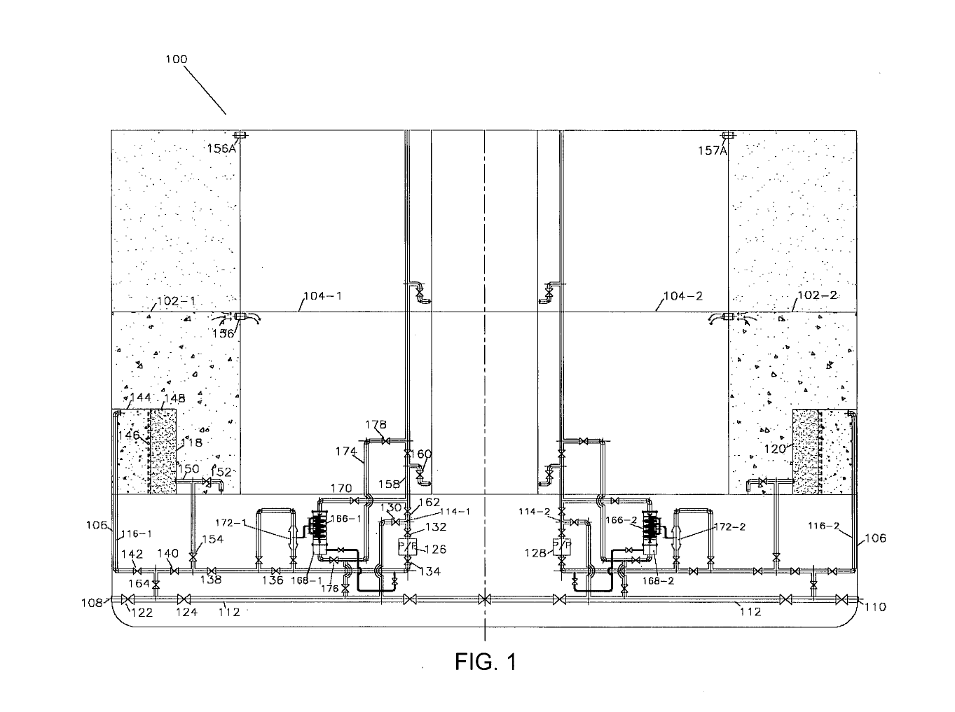

FIG. 1 illustrates a purification system 100 for purifying water in accordance with an embodiment of the invention. Purification system 100 includes one or more tanks A tank of the one or more tanks is one of a double bottom tank, a side tank, a fore peak tank and an after peak tank. One or more side tanks 102-n are dedicated for filtration of water. The water may be received from a water source such as, sea, river, ground water, sewage water, etc. Purification system 100 includes a side tank 102-1 and a side tank 102-2 for filtering the water. The filtered water from the one or more side tanks 102-n is then collected in one or more double bottom tanks 104-n. Such double bottom tanks 104-n dedicated for storing the filtered water are called dedicated double bottom tanks Purification system 100 includes a dedicated double bottom tank 104-1 and a dedicated double tank 104-2 for storing the filtered water.

Further, purification system 100 includes a pump room 106 and one or more water inlet/outlets such as, a water inlet/outlet 108 and a water inlet/outlet 110 located in pump room 106. In an embodiment of the invention, a water inlet/outlet has a grating or a wire meshing to avoid entry of debris, fishes and other obstructions into purification system 100. The one or more water inlet/outlets are controlled by a valve system which may be operated by various means such as manual and hydraulic. Purification system 100 also includes a water pipeline 112, one or more intermediate pipelines 114-n and one or more filling pipelines 116-n to facilitate circulation of the water in purification system 100. Water pipeline 112 is located in pump room 106 extending from water inlet/outlet 108 to water inlet/outlet 110. One or more filling pipelines 116-n are connected to water pipeline 112 through one or more intermediate pipelines 114-n. One or more intermediate pipelines 114-n may be an intermediate pipeline 114-1 and an intermediate pipeline 114-2. Further, one or more filling pipelines 116-n may be, a filling pipeline 116-1 and a filling pipeline 116-2. Thus, filling pipeline 116-1 is connected to water pipeline 112 through intermediate pipeline 114-1. Similarly, filling pipeline 116-2 is connected to water pipeline 112 through intermediate pipeline 114-2.

Filling pipeline 116-1 and filling pipeline 116-2 extends to top of side tank 102-1 and side tank 102-2, respectively. Filling pipeline 116-1 and filling pipeline 116-2 fills the water in one or more filtering units configured within a side tank 102-1 and one or more filtering units configured within side tank 102-2, respectively. Purification system 100 includes a filtering unit 118 and a filtering unit 120 configured within side tank 102-1 and side tank 102-2, respectively. Filling pipeline 116-1 and filling pipeline 116-2 may fill the water into filtering unit 118 and filtering unit 120. A filtering unit of the one or more filtering units may be a tank floating in a side tank of one or more side tanks 102-n.

The water received within the one or more filtering units is initially fed into water pipeline 112 from the water source through the one or more water inlet/outlets. Thereafter, the water is fed into intermediate pipeline 114-1 and intermediate pipeline 114-2. In purification system 100, water pipeline 112 feeds the water into intermediate pipeline 114-1 through a valve 122 and a valve 124. The water is then pumped-in from intermediate pipeline 114-1 and intermediate pipeline 114-2 into filling pipeline 116-1 and filling pipeline 116-2, respectively using one or more ballast pumps such as, a ballast pump 126 and ballast pump 128. Ballast pump 126 and ballast pump 128 may be configured within pump room 106. In purification system 100, the water present in intermediate pipeline 114-1 passes into ballast pump 126 through a valve 130 and valve 132. Thereafter, the water is pumped-in by ballast pump 126 into filling pipeline 116-1 through a valve 134. The water then passes through valves 136, 138, 140 and 142 into filtering unit 118. In an embodiment of the invention, a filling pipeline is fitted to a filtering unit of the one or more filtering units to supply the water to the filtering unit. Alternatively, multiple filling pipelines may be fitted to a filtering unit of the one or more filtering units to supply the water to the filtering unit.

The water collected in the one or more filtering units undergo a filtration process to obtain filtered water. Each filtering unit of the one or more filtering units includes a first chamber, a filtering medium and a second chamber. Filtering unit 118 includes a first chamber 144, a filtering medium 146 and a second chamber 148. Similarly, filtering unit 120 may have a first chamber, a filtering medium and a second chamber (not numbered in FIG. 1). The water is initially received by first chamber 144 therewithin through filling pipeline 116-1. Filling pipeline 116-1 may be fitted to first chamber 144. The water is then passed through filtering medium 146 configured within filtering unit 118. The water may be equally distributed throughout the surface of filtering medium 146. In an embodiment of the invention, filtering unit 118 may include multiple filtering mediums for filtering the water within filtering unit 118. Filtering medium 146 filters the water to obtain the filtered water. Filtering medium 146 may include one or more of sand, rubber, diatomite, gravel and pebbles. Similarly, a filtering medium configured within the filtering unit 120 may include one or more of sand, rubber, diatomite and gravel. However, it will be obvious to a person skilled in the art that the filtering medium may include any other materials known in the art that facilitates filtering of the water. Thereafter, the filtered water from filtering medium 146 is collected in second chamber 148.

The filtered water from second chamber 148 initially passes into side tank 102-1 through a filter chamber pipeline 150 connected to filtering unit 118. Filter chamber pipeline 150 may be connected to second chamber 148 of filtering unit 118. A valve 152 configured in filter chamber pipeline 150 is opened to allow the filtered water to flow into side tank 102-1. Filter chamber pipeline 150 is connected to filling pipeline 116-1 through a valve 154. Valve 154 is closed when the filtered water flows into side tank 102-1. Thereafter, the filtered water is channeled into double bottom tank 104-1 i.e., a dedicated double bottom tank 104-1 from side tank 102-1. In an embodiment of the invention, a side tank and a double bottom tank are directly interconnected through one or more perforations present at bottom of the side tank. The water is fed from the side tank through the one or more perforations into the double bottom tank due to gravitational force. In purification system 100, filtered water is channeled into double bottom tank 104-1 through a perforation 156 configured at the bottom of side tank 102-1. Double bottom tank 104-1 stores the filtered water.

The filtered water continuously collected in double bottom tank 104-1 increases a level of the filtered water in double bottom tank 104-1 thereby raising the level of the filtered water in side tank 102-1. In an embodiment of the invention, the level of the filtered water in side tank 102-1 and double bottom tank 104-1 together may be up to 30 meters thereby creating a high pressure head.

Referring to the filtering medium for filtering the water in the filtering unit of the one or more filtering units, the filtering medium may include contaminating matter accumulated thereon during the filtration of the water. The accumulation of the contaminating matter may result in reduced amount of the water being filtered by the filtering medium. Thus to remove the contaminating matter accumulated in the filtering medium, the contaminating matter is flushed out using the filtered water from the one or more double bottom tanks The filtered water from a double bottom tank initially passes through a feeding pipeline connected to the double bottom tank. Thereafter, the filtered water from the feeding pipeline is pumped into the filling pipeline and subsequently to the second chamber of the filtering unit of the one or more filtering units through the filter chamber pipeline connected to the second chamber. Thereafter, the filtered water passes through the filtering medium to remove the contaminating matter.

In purification system 100, the filtered water from double bottom tank 104-1 is fed into a feeding pipeline 158 by opening a valve 160. The filtered water from feeding pipeline 158 is then fed into a ballast pump 126 through a valve 162 and valve 132. Valves 162 and 132 are in the open state when the filtered water flows into ballast pump 126. Further at this stage, valve 130 is closed. Thereafter, the filtered water is pumped into filling pipeline 116-1 by ballast pump 126 through a valve 134. Valves 136 and 138 are opened to allow the filtered water to flow through filling pipeline 116-1. At this stage, valve 140 is closed. The filtered water then enters filter chamber pipeline 150 connected to filtering unit 118 through valve 154 that is opened to allow the filtered water to flow. Valve 152 is closed at this stage to restrict the flow of the filtered water into side tank 102-1. The filtered water then flows into second chamber 148 of filtering unit 118. Subsequently, the filtered water is flushed through filtering medium 146 to remove the contaminating matter accumulated in filtering medium 146. The flushed water along with the contaminating matter enters first chamber 144 and thereafter flows into filling pipeline 116-1. Valve 142 and a valve 164 are opened to allow the flushed water along with the contaminating matter to flow into water pipeline 112. Further, valve 124 remains closed thereby restricting the flushed water along with the contaminating matter from flowing into ballast pump 126. The flushed water along with the contaminating matter is then discharged through water inlet/outlet 108 by opening valve 122. The flushed water along with the contaminating matter may be flushed into the water source or any other location. By removing the contaminating matter from the filtering medium a rate of intake of water to be filtered and a rate of supply the filtered water can be balanced so that there is a continuous flow of water through the filtering unit in purification system 100.

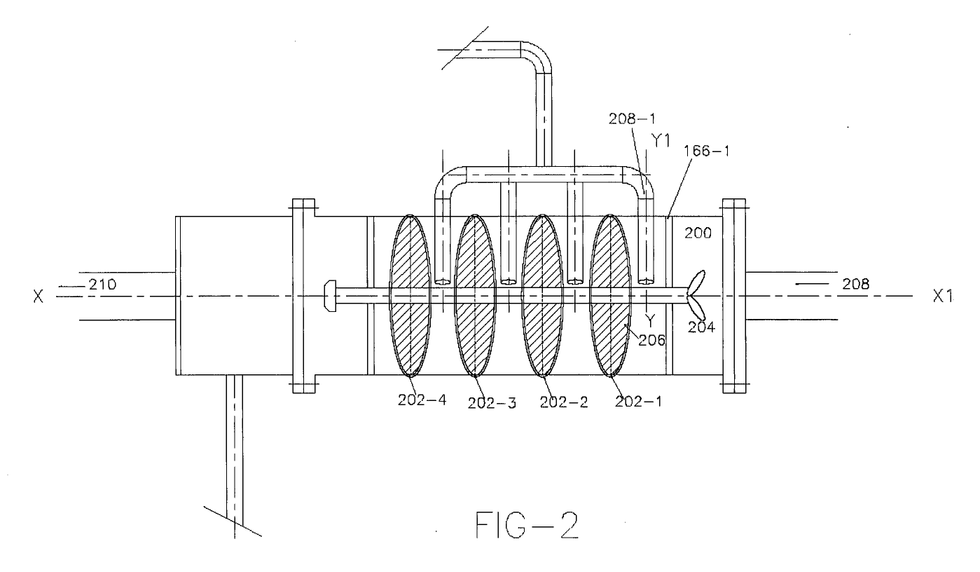

Referring back to the filtered water present in the one or more double bottom ballast tanks 104-n, the filtered water undergoes a purification process in purification system 100. The filtered water from one or more double bottom tanks 104-n is initially re-filtered by one or more filter turbines 176-n. Thereafter, the re-filtered water is purified in one or more treatment units 168-n. Purification system 100 includes a filter turbine 166-1, a filter turbine 166-2, a treatment unit 168-1 and a treatment unit 168-2. Filter turbine 166-1, filter turbine 166-2, treatment unit 168-1 and treatment unit 168-2 are located in pump room 106. Filter turbine 166-1 and a filter turbine 166-2 are configured to re-filter the filtered water received from double bottom tank 104-1 and double bottom tank 104-2. Filter turbine 166-1 receives the filtered water from double bottom tank 104-1 through feeding pipeline 158 connecting filter turbine 166-1 and double bottom tank 104-1. The filtered water passes into filter turbine 166-1 through a valve 160 and a valve 170. Valves 160 and 170 may be in an open state to allow the filtered water to enter filter turbine 166-1. Filter turbine 166-1 re-filters the filtered water received from double bottom tank 104-1 to obtain re-filtered water. In an embodiment of the invention, filter turbine 166-1 may re-filter the filtered water stored in other tanks of the one or more tanks Filter turbine 166-1 includes one or more filter disks (not shown in FIG. 1) for re-filtering the filtered water. The one or more filter disks removes contaminating matter present in the filtered water passing through the one or more filter disks. A filter turbine, such as filter turbine 166-1 for filtering the filtered water is explained in detail in conjunction with FIG. 2.

During the re-filtration process, the contaminating matter gets accumulated in the one or more filter disks. The contaminating matter is removed by one or more eductor units 172-n. Purification system 100 includes an eductor unit 172-1 and an eductor unit 172-2 for removing the contaminating matter. An eductor unit such as, eductor unit 172-1 for cleaning the one or more filter disks is explained in detail in conjunction with FIG. 2

The re-filtered water from filter turbine 166-1 is then fed into treatment unit 168-1 connected to filter turbine 166-1. Treatment unit 168-1 purifies the re-filtered water by disinfecting the re-filtered water. In an embodiment of the invention, treatment unit 168-1 may be an Ultraviolet radiation unit capable of killing microorganisms such as bacteria, present in the re-filtered water to obtain purified water. The purified water is then fed into other tanks through a distributing pipeline 174 connected to treatment unit 168-1 system 100. Valves 176 and 178 present in distributing pipeline 174 are opened to allow the purified water to pass into the other tanks of the one or more tanks.

FIG. 2 illustrates a section view of filter turbine 166-1 in accordance with an embodiment of the present invention. Filter turbine 166-1 includes an axle 200, one or more filter disks 202-n and an impeller 204. One or more filter disks 202-n are mounted on axle 200 along a common axis X-X′ of rotation of axle 200. As shown in FIG. 2, common axis X-X′ is the axis of rotation of axle 200 and one or more filter disks 202-n. One or more filter disks 202-n such as a filter disk 202-1, a filter disk 202-2, a filter disk 202-3, and a filter disk 202-4 are spaced apart from each other on axle 200. In an embodiment of the invention, filter disk 202-1, filter disk 202-2, filter disk 202-3 and filter disk 202-4 are equidistantly spaced apart from each other. However, it will apparent to a person skilled in the art that the one or more filter disks may be configured on an axle of a filter turbine in any other manner.

Each filter disk of one or more filter disks 202-n include one or more meshes. A filter disk such as, filter disk 202-1 may include one or more meshes. Filter disk 202-1 includes a mesh 206 as shown in FIG. 2. In an embodiment of the invention, a mesh of the one or more meshes is a wire mesh. The mesh may be made of a non-corrosive material. For example, the mesh may be made of a fine sintered stainless steel material. It will be apparent to a person skilled in the art that the mesh may be made of any non-corrosive material and toughened material known in the art.

Further, mesh size of the mesh may be one of 40, 30, 20, 10 and 5 microns. Thus, the mesh enables the filter turbine to re-filter the filtered water to very small micron levels. However, the mesh may be of any mesh size that is known in the art. In an embodiment of the invention, each filter disk of one or more filter disks 202-n may have a mesh of different mesh size. Alternatively, a filter disk of one or more filter disks 202-n may include one or more meshes, each mesh of the one or more meshes having different mesh size.

Further, impeller 204 is operatively coupled to an end of axle 200. During operation, impeller 204 rotates axle 200 to in turn rotate one or more filter disks 202-n. The filtered water flows into filter turbine 166-1 through an inlet 208. In an embodiment of the invention, impeller 204 is operated by the filtered water flowing into filter turbine 166-1. In an embodiment of the invention, impeller 204 operates under a gravitational force of a pressure head created by high water level of the filtered water in side tank 102-1 and double bottom tank 104-1. Alternatively, impeller 204 is operated by a gear mechanism (not shown) configured within purification system 100. It will be apparent to a person skilled in the art any other operating mechanisms known in the art may be employed to operate impeller 204.

The filtered water flowing into filter turbine 166-1 flows through each filter disk of one or more filter disks 202-n. One or more filter disks 202-n removes the contaminating matter from the filtered water to obtain the re-filtered water. Due to prolong re-filtration process or after multiple re-filtration cycles, the contaminating matter accumulates on the one or more filter disks thereby affecting the continuous flow of filtered water through the filter turbine. As a result, a rate of supply of filtered water into the filter turbine may be greater than a rate of re-filtered water flowing out of the filter turbine.

An eductor unit may be employed to remove the contaminating matter accumulated on the one or more filter disks. The eductor unit operates to pull out the contaminating matter from the one or more filter disks using one or more suction pipes. Eductor unit 172-1 (not shown in FIG. 2) include one or more suction pipes 208-n to remove the contaminating matter from one or more filter disks 202-n. A suction pipe may be configured closer to a filter disk corresponding to the suction pipe to enable the suction pipe to remove the contaminating matter from the filter disk as shown in FIG. 2. More specifically, the suction pipe is configured in such way that a line of axis Y-Y′ of the suction pipe may be perpendicular to the common axis X-X′ of axle 200. However, it will be apparent to a person skilled in the art that the one or more suction pipes may be arranged with respect to the one or more filter disks in any other manner to remove the contaminating matter from the one or more filter disks. Eductor unit 172-1 includes a suction pipe 208-1 configured closer to filter disk 202-1 as shown in FIG. 2 to pull out the contaminating matter from filter disk 202-1 thereby cleaning filter disk 202-1.

The re-filtered water from filter turbine 166-1 then enters treatment unit 168-1. Treatment unit 168-1 then disinfects the re-filtered water to obtain the purified water. After the treatment process, the purified water is discharged through an outlet 210. The purified water may be discharged by filtered water flowing into filter turbine 166-1. Thereafter, the purified water is supplied into other tanks of the one or more tanks for storage.

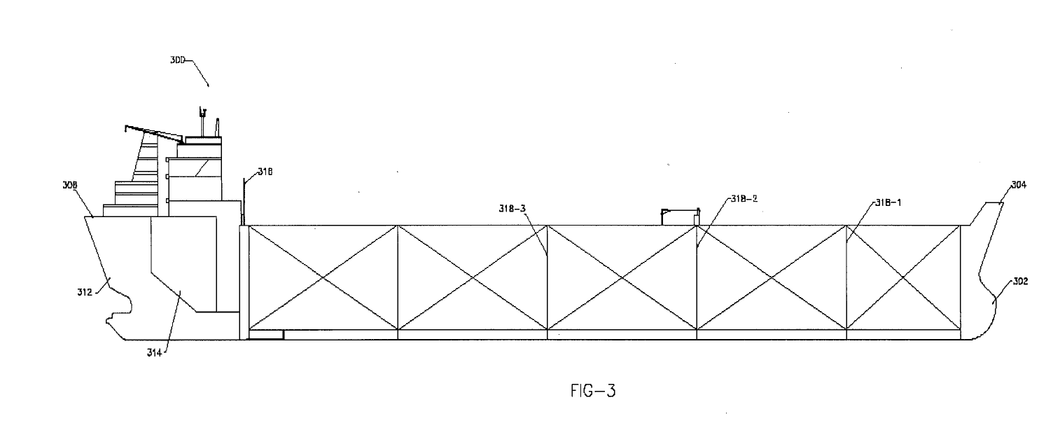

FIG. 3 illustrates a longitudinal section view of a water vessel 300. Water vessel 300 may be for example, a sea vessel. Water vessel 300 includes a fore peak ballast tank 302, a bow 304, a stern 306, an after peak ballast tank 312, a machinery space 314, a pump room 316 and one or more transverse bulkheads 318-n. Bow 304 is forward most part of a hull of water vessel 300. Stern 306 is rear most part of the hull of water vessel 300. Fore peak ballast tank 302 located in forward part of water vessel 300 and after peak ballast tank 312 located in rear part of water vessel 300 are used for storing ballast water. Transverse bulkheads 318-n partition water vessel 300 into one or more compartments. As shown in FIG. 1, transverse bulkheads 318-n can be for example, a transverse bulkhead 318-1, a transverse bulkhead 318-2 and a transverse bulkhead 318-3.

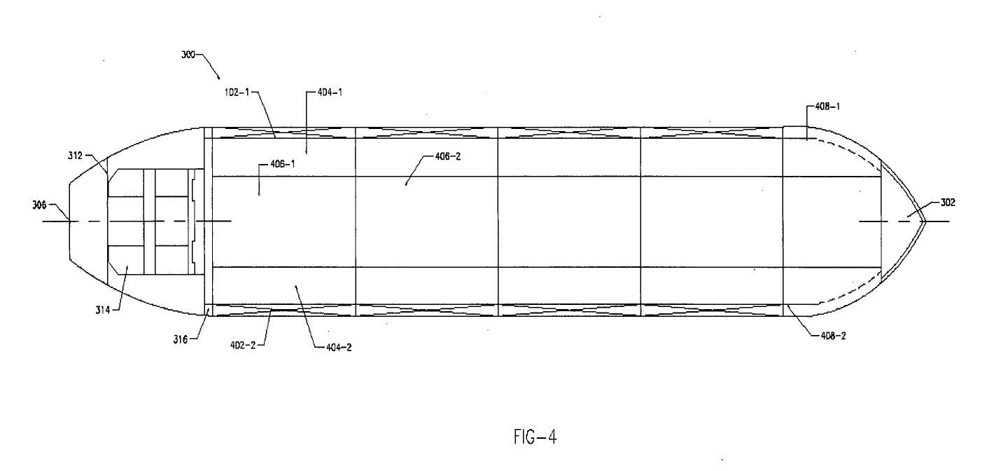

FIG. 4 illustrates a transverse section view corresponding to axis A-A′ of water vessel 300 as shown in FIG. 3. Water vessel 300 includes one or more side segregated ballast tanks 402-n, one or more side cargo tanks 404-n, one or more center cargo tanks 406-n and one or more longitudinal bulkheads 408-n. Also, FIG. 4 depicts various elements from FIG. 3 in accordance with the invention. Center cargo tanks 406-n and side cargo tanks 404-n are used for storing cargo. Center cargo tanks 406-n are located along central longitudinal axis of the hull of water vessel 300. Center cargo tanks 406-n may be, for example, a center cargo tank 406-1 and a center cargo tank 406-2. Also as depicted, side cargo tanks 404-n are located on both sides of water vessel 300 adjoining center cargo tanks 406-n. Side cargo tanks 404-n extend from main deck level to bottom level of center cargo tanks 406-n. Side cargo tanks 404-n can be, for example, a side cargo tank 404-1 and a side cargo tank 404-2. Further, side segregated ballast tanks 402-n are located on both sides of water vessel 300 for storing ballast water. Side segregated ballast tanks 402-n extend from main deck level to bottom level of center cargo tanks 406-n. Side segregated ballast tanks 402-n can be, for example, a side segregated ballast tank 402-1 and a side segregated ballast tank 402-2. Longitudinal bulkheads 408-n partition water vessel 300 into one or more compartments. As shown in FIG. 4, longitudinal bulkheads 408-n can be, for example, a longitudinal bulkhead 408-1 and a longitudinal bulkhead 408-2.

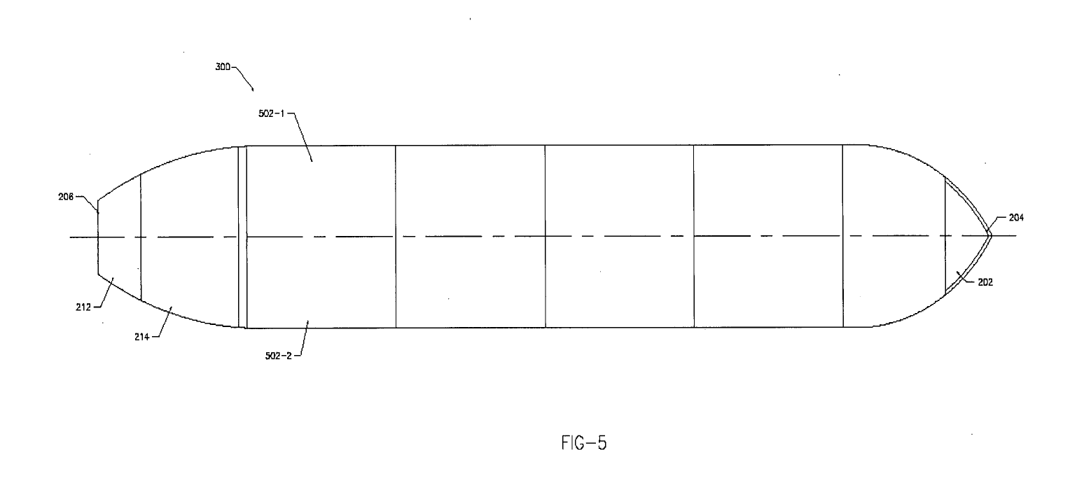

FIG. 5 illustrates a transverse section view corresponding to axis B-B′ of water vessel 300 as shown in FIG. 3. Water vessel 300 includes one or more double bottom segregated ballast tanks 502-n. Also, FIG. 5 depicts various elements from FIG. 3 in accordance with the invention. Double bottom segregated ballast tanks 502-n extend below center cargo tanks 406-n, side cargo tanks 404-n and side segregated ballast tanks 402-n (as shown in FIG. 4). Double bottom segregated ballast tanks 502-n are used for storing ballast water. As shown in FIG. 5, double bottom segregated ballast tanks 502-n can be, for example, a double bottom segregated ballast tank 502-1 and a double bottom segregated ballast tank 502-2.

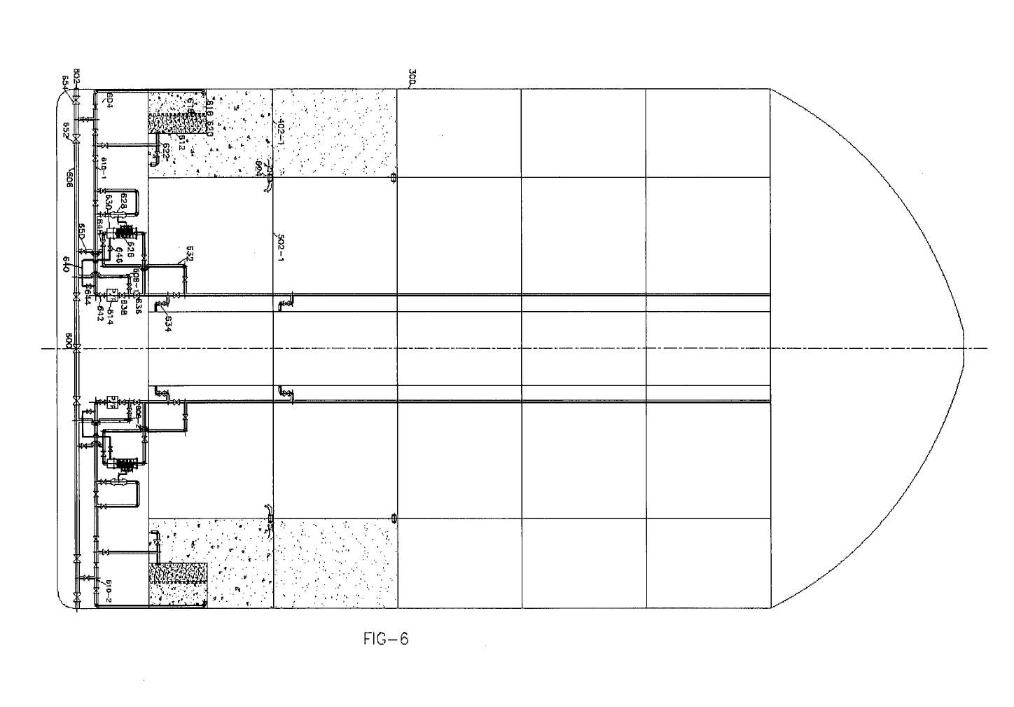

FIG. 6 illustrates a cross-section view of water vessel 300 showing a purification system in accordance with an embodiment of the invention. The purification system in water vessel 300 functions in a similar to purification system 100 shown in FIG. 1. Further, the purification system includes various elements that function in a similar as elements in purification system 100 as described in FIG. 1. Thus, FIG. 6 depicts various elements from FIG. 1. Further, a double bottom tank of one or more double bottom tanks, a side tank of one or more side tanks, a fore peak tank and a after peak tank of purification system may be a ballast tank. Therefore, a side segregated ballast tank and a double bottom segregated ballast tank in the purification system functions in a similar manner as a side tank and a double bottom tank in purification system 100 (as shown in FIG. 1). Moreover, FIG. 6 depicts various elements from FIGS. 3-5.

One or more side segregated ballast tanks 402-n are dedicated for filtration of the ballast water. Water vessel 300 includes side segregated ballast tank 402-1 and side segregated ballast tank 402-2 (not shown) for filtering the ballast water. The filtered water from the one or more side segregated tank 402-n is then collected in one or more double bottom segregated ballast tanks 502-n (as shown in FIG. 3). Such double bottom segregated ballast tanks 502-n dedicated for storing the filtered ballast water are called dedicated double bottom segregated ballast tanks Water vessel 300 includes a dedicated double bottom segregated ballast tank 502-1 and a dedicated double bottom segregated ballast tank 502-2 (not shown).

Water vessel 300 is divided into a port side and a starboard side (not shown) of water vessel 300 by a center girder 600. In FIG. 6, dedicated double bottom segregated ballast tank 502-1 and side segregated ballast tank 402-1 are located on the port side of water vessel 300. Dedicated double bottom segregated ballast tank 502-2 and side segregated ballast tank 402-2 (not shown in FIG. 6) are located on the starboard side of water vessel 300.

Further, water vessel 300 includes one or more water inlet/outlet such as, a port side water inlet/outlet 602 and a starboard side water inlet/outlet (not shown) located in pump room 604. In an embodiment of the invention, port side water inlet/outlet 602 has a grating or a wire meshing to avoid entry of big fish, debris and other obstructions in water vessel 300. For example, in a water vessel such as a sea vessel, a water inlet/outlet of one or more water inlet/outlet may be a sea chest. Port side water inlet/outlet 602 is controlled by a valve system which may be operated by various means such as manual and hydraulic. Water vessel 300 also includes a water pipeline 606, one or more intermediate pipelines 608-n and one or more filling pipelines 610-n to facilitate circulation of the water through the purification system. Water pipeline 606 is located in pump room 604 extending from port side water inlet/outlet 602 and the starboard side water inlet/outlet. One or more filling pipelines 610-n are connected to water pipeline 606 through one or more intermediate pipelines 608-n. Water vessel 300 includes a filling pipeline 610-1 connected to water pipeline 606 through intermediate pipeline 608-1.

Filling pipeline 610-1 extends to top of side segregated ballast tank 402-1. Filling pipeline 610-1 fills the ballast water in one or more filtering units configured within a side segregated ballast tank 402-1. Water vessel 300 includes a filtering unit 612 configured within side segregated ballast tank 402-1. Filling pipeline 610-1 may fill the ballast water into filtering unit 612. Filtering unit 612 may be a tank floating in side segregated ballast tank 402-1.

The water received within filtering unit 612 is initially fed into water pipeline 606 from a water source such as, sea, river, lake, etc. through one of the port side water inlet/outlet 602 and the starboard side water inlet/outlet. Thereafter, the ballast water is fed into intermediate pipeline 608-1. This is explained in detail in conjunction with FIG. 1. The ballast water is then pumped-in from intermediate pipeline 608-1 into filling pipeline 610-1 using a ballast pump 614. Ballast pump 614 is configured within pump room 604. The process of channeling the ballast water from intermediate pipeline 608-1 into filling pipeline 610-1 is explained in detail in conjunction with FIG. 1.

The water collected in filtering unit 612 undergoes a filtration process to obtain filtered water. Filtering unit 612 includes a first chamber 616, a filtering medium 618 and a second chamber 620. The water is initially received by first chamber 616 therewithin through filling pipeline 610-1. Filling pipeline 610-1 may be fitted to first chamber 616. The water is then passed through filtering medium 618 configured within filtering unit 612. The water may be equally distributed throughout the surface of filtering medium 618. Filtering medium 618 filters the water to obtain the filtered water. During filtration of the ballast water, contaminating matter accumulates in filtering medium 618. The process of removing the contaminating matter from a filtering medium is explained in detail in conjunction with FIG. 1. Thereafter, the filtered water from filtering medium 618 is collected in second chamber 620.

The filtered water from second chamber 620 initially passes into side segregated ballast tank 402-1 through a filter chamber pipeline 622 connected to filtering unit 612. Filter chamber pipeline 622 may be connected to second chamber 620 of filtering unit 612. The process of channeling the filtered water into side segregated ballast tank 402-1 is explained in detail in conjunction with FIG. 1. Thereafter, the filtered water is channeled into double bottom segregated ballast tank 502-1 from side segregated ballast tank 402-1. In an embodiment of the invention, a side segregated ballast tank and a double bottom segregated ballast tank are directly interconnected through one or more perforations present at bottom of the side segregated ballast tank. During ballasting of the side segregated ballast tank, ballast water is fed from the side segregated ballast tank through one or more perforations present at bottom of the side segregated ballast tank into the double bottom segregated ballast tank due to gravitational force. In water vessel 300, filtered water is channeled into double bottom segregated ballast tank 502-1 through a perforation 624 configured at the bottom of side segregated ballast tank 402-1. Double bottom segregated ballast tank 502-1 stores the filtered water.

The filtered water present in the double bottom segregated ballast tank 502-1 undergoes a purification process in water vessel 300. The filtered water from double bottom segregated ballast tank 502-1 is initially re-filtered by one or more filter turbines. Water vessel 300 includes a filter turbine 626. Filter turbine 626 receives the filtered water from double bottom segregated ballast tank 502-1 and subsequently re-filters the filtered water. A filter turbine of the one or more filter turbines is designed to meet IMO-D2 standards in such a manner to filter the water efficiently. During the re-filtration process, the contaminating matter gets accumulated in one or more filter disks of filter turbine 626. The one or more filter disks and filter turbine are explained in detail in conjunction with FIGS. 1 and 2. The contaminating matter is removed by one or more eductor units. Water vessel 300 includes an eductor unit 628 for removing the contaminating matter from the one or more filter disks. The process of removing the contaminating matter using an eductor unit is explained in detail in conjunction with FIGS. 1 and 2.

The re-filtered water from the filter turbine is then purified in one or more treatment units. Water vessel 300 includes a treatment unit 630 for purifying the re-filtered water received from filter turbine 626. The filter turbine and treatment unit used for re-filtering and purifying the filtered water is explained in detail in conjunction with FIGS. 1 and 2. The purified water from treatment unit 630 is then fed into one or more ballast tanks in water vessel 300 through a distributing pipeline 632.

Further, in a water vessel deballasting of ballast water from the one or more ballast tanks in the water vessel occurs. During deballasting, purified water from the one or more ballast tanks is fed into the one or more treatment units for re-purification. In water vessel 300, the purified water from a ballast tank for example, double bottom segregated ballast tank 502-1 is discharged through an outlet corresponding to double bottom segregated ballast tank 502-1. The purified water enters ballast pump 614 through valves 634, 636 and 638. Valves 634, 636 and 638 may be in an open state allowing the purified water to flow into ballast pump 614. Ballast pump 614 then pumps the purified water through a purification inlet pipeline 640 connected to treatment unit 630. Valves 642, 644 and 646 remains in an open state to allow the purified water to flow into treatment unit 630.

The re-purified water from treatment unit 630 is then channeled to a water inlet/outlet of the one or more water inlet/outlet. Thus, re-purified water is channel out through port side water inlet/outlet 602 or a starboard side water inlet/outlet to the water source. The re-purified is channeled through valves 648 and 650 into water pipeline 606. Thereafter, the re-purified water is channeled to port side water inlet/outlet 602 from water pipeline 606 through valves 652 and 654. Valves 648, 650, 652 and 654 are in open state to allow the re-purified water to from treatment unit 630 to port side water inlet/outlet 602 through water pipeline 606.

Water vessel 300 may include all vessels which take in ballast water for the purpose of maintaining stability. Examples of water vessel 300 may include, but are not limited to, an oil tanker, a chemical carrier, a gas tanker, a cargo carrier, passenger ship or any water borne vessel.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method of purifying water, the method comprising:
filtering water in at least one filtering unit, wherein the at least one filtering unit is configured within a tank of at least one tank, the filtered water is collected in the tank;
re-filtering the filtered water in each filter turbine of the at least one filter turbine to obtain re-filtered water, wherein the filtered water is fed into the each filter turbine from the tank; and
purifying the re-filtered water received from a filter turbine of the at least one filter turbine by at least one treatment unit connected with the filter turbine.

2. The method of claim 1 further comprising channeling the purified water into the at least one tank subsequent to purification of the re-filtered water in the at least one treatment unit.

3. The method of claim 1, wherein the filter turbine operates under a pressure head associated with the filtered water stored in at least one tank.

4. The method of claim 1, wherein purifying the re-filtered water comprises disinfecting the re-filtered water by the at least one treatment unit.

5. The method of claim 4, wherein a treatment unit of the at least one treatment unit is an Ultraviolet radiation unit.

6. The method of claim 1, wherein a tank of the at least one tank is one of a double bottom tank, a side tank, fore peak tank and an after peak tank.

7. The method of claim 6 further comprising:
pumping-in the water from a water pipeline into a filling pipeline fitted in each filtering unit of the at least one filtering unit through a intermediate pipeline, wherein the water is fed into the water pipeline from a water origin through a water inlet/outlet of at least on water inlet/outlet; and
filling the water into a first chamber of the each filtering unit using the filling pipeline.

8. The method of claim 7, wherein filtering the water comprises:
passing the water present in the first chamber of the each filtering unit through a filtering medium configured within the each filtering unit to obtain the filtered water; and
collecting the filtered water in a second chamber of the each filtering unit.

9. The method of claim 8 further comprising:
passing the filtered water into a side tank of at least one side tank through a filter chamber pipeline connected to a filtering unit of the at least one filtering unit, the at least one filtering unit configured within the side tank; and
channeling the filtered water from the side tank to at least one double bottom tank through perforations at bottom of the side tank.

10. The method of claim 9 further comprising:
feeding the filtered water from the at least one double bottom tank into the at least one filter turbine, wherein the filtered water is fed into the at least one filter turbine through a feeding pipeline connecting the at least one filter turbine and a double bottom tank of the at least one double bottom tank; and
pumping-in the purified water from the at least one treatment unit into at least one tank through a distributing pipeline connecting the at least one treatment unit and the at least one tank.

11. The method of claim 10, wherein the water is a ballast water in a water vessel.

12. The method of claim 11, wherein each of the double bottom tank, the side tank, the fore peak tank and the after peak tank is a ballast tank.

13. The method of claim 12 further comprising ballasting the at least one ballast tank through an inlet corresponding to each ballast tank, wherein the ballasting is performed under gravity subsequent to purification of the re-filtered water by the at least one treatment unit.

14. The method of claim 12 further comprising deballasting the purified water from the at least one ballast tank, wherein the deballasting comprises:
discharging the purified water from a ballast tank of the at least one ballast tank by channeling the purified water from an outlet corresponding to the ballast tank through a treatment pipeline to the at least one treatment unit, the ballast water is pumped into the at least one treatment unit through a purification inlet pipeline connected to the treatment pipeline;
re-purifying the purified water in the at least one treatment unit; and
channeling the re-purified water from the at least one treatment unit to a water inlet/outlet of the at least one water inlet/outlet through the water pipeline.

15. The method of claim 8 further comprising removing contaminating matter accumulated in the filtering medium during filtration of the water by flushing the filtered water received from the at least one tank through the filtering medium.

16. The method of claim 15 further comprising:
discharging the filtered water from at least one double bottom tank by channeling the filtered water from an outlet corresponding to a double bottom tank of the at least one double bottom tank to a filling pipeline connected to a filtering unit of the at least one filtering unit;
pumping-in the filtered water from the filling pipeline to a second chamber of the filtering unit through a filter chamber pipeline connected to the filtering unit; and
flushing the filtered water from the second chamber into a first chamber of the filtering unit, the flushed water removing the contaminating matter accumulated in the filtering medium enters the first chamber.

17. The method of claim 16 further comprising:
discharging the flushed water carrying the contaminating matter from the first chamber of the filtering unit by forcing the flushed water and the contaminated matter to flow through the filling pipeline fitted to the filtering unit to the water pipeline; and
channeling the flushed water and the contaminated matter from the water pipeline to the water origin associated with the water through a water inlet/outlet of the at least one water inlet/outlet.

18. A system for purifying water, the system comprising:
at least one filtering unit configured within a tank of at least one tank to filter the water, wherein the filtered water is collected in the tank;
at least one filling pipeline, a filling pipeline of the at least one filling pipeline fitted to a filtering unit of the at least one filtering unit to fill the water in the filtering unit;
at least one filter turbine for re-filtering the filtered water to obtain the re-filtered water, wherein the filtered water is fed into the each filter turbine from the tank; and
at least one treatment unit for purifying the re-filtered water, wherein re-filtered water is fed into the at least one treatment unit from a filter turbine connected to the at least one filter turbine.

19. The system of claim 18, wherein the water is a ballast water in a water vessel.

20. The system of claim 18 further comprising a water pipeline connected to a water source through at least one water inlet/outlet to fill the water into each filtering unit of the at least one filtering unit and discharge purified water from the at least one tank.

21. The system of claim 18 further comprising a distributing pipeline for channeling the purified water into the at least one tank.

22. The system of claim 18, wherein the tank of the at least one tank is one of a double bottom tank, a side tank, fore peak tank and an after peak tank.

23. The system of claim 22, wherein the filtering unit of the at least one filtering unit is a tank floating in a tank of the at least one tank, wherein the tank is the side tank.

24. The system of claim 23, wherein the filtering unit of the at least one filtering unit comprises:
a first chamber for receiving the water therewithin through the filling pipeline fitted to the first chamber;
a filtering medium for filtering the ballast water received in the first chamber; and
a second chamber for collecting the filtered water.

25. The system of claim 24, wherein the filtering medium comprises at least one of sand, rubber, diatomite, gravel and pebbles.

26. The system of claim 24 further comprising a filter chamber pipeline for passing the filtered water from the second chamber of the filtering unit into a tank of the at least one tank, wherein the tank is the side tank.

27. The system of claim 18, wherein a filter turbine of the at least one filter turbine comprises:
an axle;
at least one filter disk mounted on the axle along a common axis of rotation of the axle, wherein each filter disk of the at least one filter disk is spaced apart from each other on the axle, the at least one filter disk capable of re-filtering the filtered water fed into the filter turbine; and
an impeller operatively coupled to an end of the axle, the impeller capable of rotating the axle and the at least one filter disk for re-filtering the filtered water.

28. The system of claim 27, wherein a filter disk of the at least one filter disk comprises at least one mesh for removing contaminating matter from the filtered water passing through the filter disk during the re-filtration.

29. The system of claim 28, wherein a mesh of the at least one wire mesh is made of a non-corrosive material.

30. The system of claim 29, wherein a mesh size of the mesh is one of 40, 30, 20, 10 and 5 microns.

31. The system of claim 27 further comprising at least one eductor unit, wherein an eductor unit of the at least eductor unit is configured to remove contaminating matter accumulated due to re-filtration of the filtered water from the at least one filter disk of the filter turbine.

32. The system of claim 31, wherein the eductor unit comprises at least one suction pipe, a suction pipe of the at least one suction pipe capable of removing the contaminating matter from a filter disk of the at least one filter disk.

33. The system of claim 18, wherein a treatment unit of the at least on treatment unit purifies the re-filtered water by disinfecting the re-filtered water.

34. The system of claim 33, wherein the treatment unit is an Ultraviolet radiation unit.
